(19) United States
(12) Patent Application Publication
(10) Pub. No.: US 2023/0419987 A1
(43) Pub. Date: Dec. 28, 2023

(54) DYNAMIC SPEECH ENHANCEMENT COMPONENT OPTIMIZATION

(71) Applicant: Microsoft Technology Licensing, LLC, Redmond, WA (US)

(72) Inventors: Ross G. CUTLER, Clyde Hill, WA (US); William D. FALLAS CORDERO, Belen (CR)

(73) Assignee: Microsoft Technology Licensing, LLC, Redmond, WA (US)

(21) Appl. No.: 18/072,876

(22) Filed: Dec. 1, 2022

Related U.S. Application Data
(63) Continuation-in-part of application No. 17/849,187, filed on Jun. 24, 2022.

(51) Int. Cl. G10L 25/60; G10L 19/005; G10L 25/30

(52) U.S. Cl. CPC G10L 25/60; G10L 19/005; G10L 25/30

(57) ABSTRACT

Systems, methods, and computer-readable storage devices are disclosed for optimizing speech enhancement components to use in speech communication systems using non-intrusive speech quality assessment. One method including: receiving, from a computing device over a network, audio data, the audio data including speech; detecting a first quality of the speech of the audio data using a trained non-intrusive speech quality assessment (NISQA) model, the trained NISQA model trained to detect quality of speech automatically; determining whether the computing device is a low-quality endpoint based on the first quality of speech of the audio data; and transferring, from the computing device over the network, at least one speech enhancement component to at least one server device when the computing device is determined to be a low-quality endpoint.

### CROSS-REFERENCE TO RELATED APPLICATIONS

This application is a continuation-in-part of U.S. application Ser. No. 17/849,187, filed Jun. 24, 2022.

### TECHNICAL FIELD

The present disclosure relates to enhancement of speech by reducing echo, noise, dereverberation, etc. Specifically, the present disclosure relates to speech enhancement through the use of non-intrusive speech quality assessment models using neural networks that determines speech enhancement components to use in speech communication systems.

### INTRODUCTION

In speech communication systems, audio signals may be affected by echoes, background noise, reverberation, enhancement algorithms, network impairments, etc. Providers of speech communication systems in an attempt to provide optimal and reliable services to their customers may estimate a perceived quality of the audio signals. For example, speech quality prediction may be useful during network design and development as well as for monitoring and improving customers' quality of experience (QoE).

In order to determine QoE, one method may include subjective listening test to provide an accurate method for evaluating perceived speech signal quality. In this approach, the estimated quality is an average of users' judgment. For example, the average of all participants' scores over a specific condition is referred to as the mean opinion score (MOS) and represents the perceived speech quality after leveling out individual factors. However, such approaches may be cumbersome, time consuming, and cannot be done in real time.

Intrusive methods to determine speech quality may calculate a perceptually weighted distance between a clean reference and a contaminated signal to estimate perceived speech quality. Intrusive methods are considered more accurate as they provide a higher correlation with subjective evaluations. Because these measurements are intrusive, they cannot be done in real-time, and require reference clean speech signal to estimate the MOS.

In order to overcome the limitations of subjective listening and intrusive estimates of speech quality, non-intrusive speech quality assessment (NISQA) models using neural networks have been implemented. Such NISQA models may be used to optimize the speech enhancement components in a telecommunication pipeline dynamically to improve QoE. Speech enhancement (SE) components are critical to telecommunication for reducing echo, noise, dereverberation, etc. Many of these components may be based on acoustic digital signal processing (ADSP) algorithms, but these components may be replaced by deep learning components. However, the deep neural network (DNN) models are only as good as the data used to train them, and it is impossible to have completely representative training data. Therefore, some new SE components may do more harm than good compared to their previous SE component. Thus, there is a need to dynamically select speech enhancement components in real time that optimize the quality of experience of users.

### SUMMARY OF THE DISCLOSURE

According to certain embodiments, systems, methods, and computer-readable media are disclosed for optimizing speech enhancement components in speech communication systems using non-intrusive speech quality assessment.

According to certain embodiments, a computer-implemented method for optimizing speech enhancement components in speech communication systems using non-intrusive speech quality assessment is disclosed. One method comprising: receiving, from a computing device over a network, audio data, the audio data including speech; detecting a first quality of the speech of the audio data using a trained non-intrusive speech quality assessment (NISQA) model, the trained NISQA model trained to detect quality of speech automatically; determining whether the computing device is a low-quality endpoint based on the first quality of speech of the audio data being; and transferring, from the computing device over the network, at least one speech enhancement component to at least one server device when the computing device is determined to be a low-quality endpoint.

According to certain embodiments, a system for optimizing speech enhancement components in speech communication systems using non-intrusive speech quality assessment is disclosed. One system including: a data storage device that stores instructions for optimizing speech enhancement components in speech communication systems using non-intrusive speech quality assessment; and a processor configured to execute the instructions to perform a method including: receiving, from a computing device over a network, audio data, the audio data including speech; detecting a first quality of the speech of the audio data using a trained non-intrusive speech quality assessment (NISQA) model, the trained NISQA model trained to detect quality of speech automatically; determining whether the computing device is a low-quality endpoint based on the first quality of speech of the audio data being; and transferring, from the computing device over the network, at least one speech enhancement component to system when the computing device is determined to be a low-quality endpoint.

According to certain embodiments, a computer-readable storage device storing instructions that, when executed by a computer, cause the computer to perform a method for optimizing speech enhancement components in speech communication systems using non-intrusive speech quality assessment is disclosed. One method of the computer-readable storage devices including: receiving, from a computing device over a network, audio data, the audio data including speech; detecting a first quality of the speech of the audio data using a trained non-intrusive speech quality assessment (NISQA) model, the trained NISQA model trained to detect quality of speech automatically; determining whether the computing device is a low-quality endpoint based on the first quality of speech of the audio data being; and transferring, from the computing device over the network, at least one speech enhancement component to at least one server device when the computing device is determined to be a low-quality endpoint.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

In the course of the detailed description to follow, reference will be made to the attached drawings. The drawings show different aspects of the present disclosure and, where appropriate, reference numerals illustrating like structures, components, materials and/or elements in different figures are labeled similarly. It is understood that various combinations of the structures, components, and/or elements, other than those specifically shown, are contemplated and are within the scope of the present disclosure.

Moreover, there are many embodiments of the present disclosure described and illustrated herein. The present disclosure is neither limited to any single aspect nor embodiment thereof, nor to any combinations and/or permutations of such aspects and/or embodiments. Moreover, each of the aspects of the present disclosure, and/or embodiments thereof, may be employed alone or in combination with one or more of the other aspects of the present disclosure and/or embodiments thereof. For the sake of brevity, certain permutations and combinations are not discussed and/or illustrated separately herein.

FIG. 1 depicts an exemplary speech enhancement architecture of a speech communication system pipeline, according to embodiments of the present disclosure.

FIG. 2 depicts another exemplary speech enhancement architecture of a speech communication system pipeline, according to embodiments of the present disclosure.

FIG. 3 depicts yet another exemplary speech enhancement architecture of a speech communication system pipeline, according to embodiments of the present disclosure.

FIG. 4 depicts still yet another exemplary speech enhancement architecture of a speech communication system pipeline, according to embodiments of the present disclosure.

FIG. 5 depicts a cloud-based exemplary speech enhancement architecture of a speech communication system pipeline, according to embodiments of the present disclosure.

FIG. 6 depicts a method for optimizing speech enhancement components to use in speech communication systems using non-intrusive speech quality assessment, according to embodiments of the present disclosure.

FIG. 7 depicts another method for optimizing speech enhancement components to use in speech communication systems using non-intrusive speech quality assessment, according to embodiments of the present disclosure.

FIG. 8 depicts a high-level illustration of an exemplary computing device that may be used in accordance with the systems, methods, and computer-readable media disclosed herein, according to embodiments of the present disclosure.

FIG. 9 depicts a high-level illustration of an exemplary computing system that may be used in accordance with the systems, methods, and computer-readable media disclosed herein, according to embodiments of the present disclosure.

Again, there are many embodiments described and illustrated herein. The present disclosure is neither limited to any single aspect nor embodiment thereof, nor to any combinations and/or permutations of such aspects and/or embodiments. Each of the aspects of the present disclosure, and/or embodiments thereof, may be employed alone or in combination with one or more of the other aspects of the present disclosure and/or embodiments thereof. For the sake of brevity, many of those combinations and permutations are not discussed separately herein.

### DETAILED DESCRIPTION OF EMBODIMENTS

One skilled in the art will recognize that various implementations and embodiments of the present disclosure may be practiced in accordance with the specification. All of these implementations and embodiments are intended to be included within the scope of the present disclosure.

As used herein, the terms “comprises,” “comprising,” “have,” “having,” “include,” “including,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.” Additionally, the term “or” is intended to mean an inclusive “or” rather than an exclusive “or.” That is, unless specified otherwise, or clear from the context, the phrase “X employs A or B” is intended to mean any of the natural inclusive permutations. For example, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

For the sake of brevity, conventional techniques related to systems and servers used to conduct methods and other functional aspects of the systems and servers (and the individual operating components of the systems) may not be described in detail herein. Furthermore, the connecting lines shown in the various figures contained herein are intended to represent exemplary functional relationships and/or physical couplings between the various elements. It should be noted that many alternative and/or additional functional relationships or physical connections may be present in an embodiment of the subject matter.

Reference will now be made in detail to the exemplary embodiments of the disclosure, examples of which are illustrated in the accompanying drawings. Wherever possible, the same reference numbers will be used throughout the drawings to refer to the same or like parts.

The present disclosure generally relates to, among other things, a methodology to dynamically optimize speech enhancement components using machine learning, such as a NISQA model using a neural network, to improve QoE in speech communication systems. There are various aspects of speech enhancement that may be improved through the use of a NISQA model, as discussed herein.

Embodiments of the present disclosure provide a machine learning approach which may be used to dynamically optimize speech enhancement components of a speech communication system. In particular, neural networks may be used as the machine learning approach. More specifically, a NISQA using neural networks may be implemented. The approach of embodiments of the present disclosure may be based on training one or more NISQA using neural networks to dynamically optimize speech enhancement components of speech communication systems. Neural networks that may be used include, but not limited to, deep neural networks, convolutional neural networks, recurrent neural networks, etc.

Non-limiting examples of speech enhancement components include music detection, acoustic echo cancelation, noise suppression, dereverberation, echo detection, automatic gain control, voice activity detection, jitter buffer management, packet loss concealment, etc.

A NISQA using neural networks may be trained using a dataset using crowd-based QoE estimation. One example of a NISQA using a neural network is shown in Table 1 below. Although table 1 depicts one type of neural network based NISQA, other types of neural networks based NISQA may be implemented within the scope of the present disclosure.

TABLE 1

| Layer | Output dimension |
|---|---|
| Input | 900 × 120 × 1 |
| Conv: 128, (3 × 3), ‘ReLU’ | 900 × 161 × 128 |
| Conv: 64, (3 × 3), ‘ReLU’ | 900 × 161 × 64 |
| Conv: 64, (3 × 3), ‘ReLU’ | 900 × 161 × 64 |
| Conv: 32, (3 × 3), ‘ReLU’ | 900 × 161 × 32 |
| MaxPool: (2 × 2), Dropout(0.3) | 450 × 80 × 32 |
| Conv: 32, (3 × 3), ‘ReLU’ | 450 × 80 × 32 |
| MaxPool: (2 × 2), Dropout(0.3) | 225 × 40 × 32 |
| Conv: 32, (3 × 3), ‘ReLU’ | 112 × 20 × 32 |
| MaxPool: (2 × 2), Dropout(0.3) | 112 × 15 × 32 |
| Conv: 64, (3 × 3), ‘ReLU’ | 112 × 20 × 64 |
| GlobalMaxPool | 1 × 64 |
| Dense: 128, ‘ReLU’ | 1 × 128 |
| Dense: 64, ‘ReLU’ | 1 × 64 |
| Dense: | 1 or 3 1 × 1 or 1 × 3 |

Another type of NISQA using neural networks includes convolution neural network (CNN) architectures. For example, CNN architectures may be applied on a 2D image arrays, and may include two operations: convolution and pooling. Convolutional layers may be responsible for mapping, into their units, detected features from receptive fields in previous layers, which may be referred to as a feature map and is the result of a weighted sum of the input features passed through a non-linearity such as ReLU. A pooling layer may take the maximum and/or average of a set of neighboring feature maps, reducing dimensionality by merging semantically similar features.

Yet another type of NISQA using neural networks includes a multilayer perceptron (MLP). Such a deep neural network (DNN) may learn feature representation by mapping the input features into a linearly separable feature space, may be achieved by successive linear combinations of the input variables followed by a nonlinear activation function. As mentioned above, other types of neural networks based NISQA may be implemented within the scope of the present disclosure.

Embodiments, as disclosed herein, dynamically optimize speech enhancement components of speech communication systems. One solution may be to use a NISQA to optimize one or more speech enhancement components in a speech communication system pipeline dynamically and/or in real time.

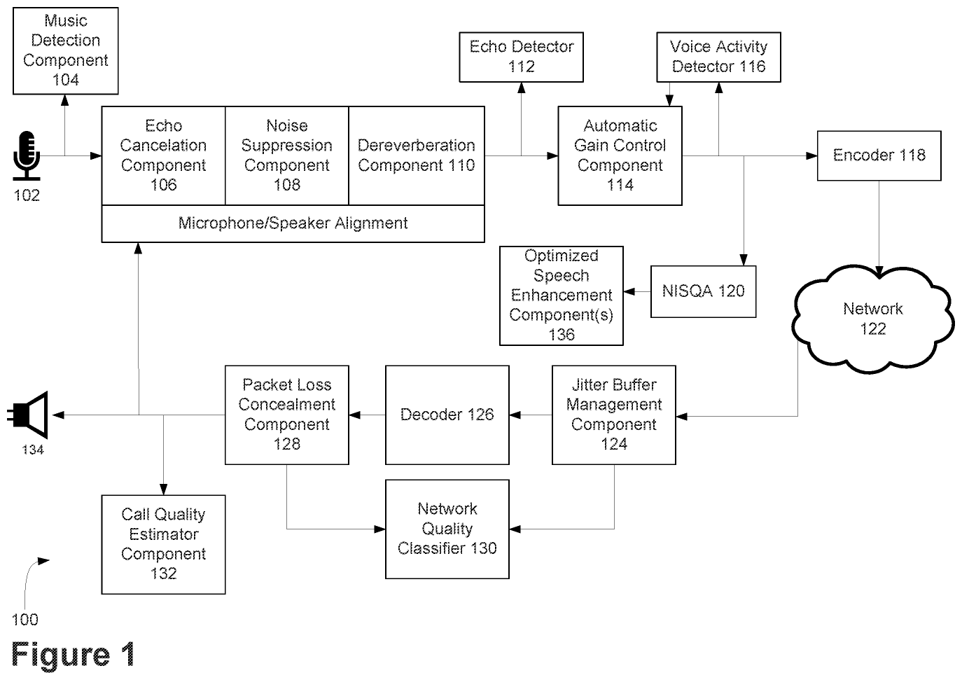

FIG. 1 depicts an exemplary speech enhancement architecture 100 of a speech communication system pipeline, according to embodiments of the present disclosure. Specifically, FIG. 1 depicts speech communication system pipeline having a plurality of speech enhancement components. As shown in FIG. 1, a microphone 102 may capture audio data including, among other things, speech of a user of the communication system. The audio data captured by microphone 102 may be processed by one or more speech enhancement components of the speech enhancement architecture 100. As mentioned above, non-limiting examples of speech enhancement components include music detection, acoustic echo cancelation, noise suppression, dereverberation, echo detection, automatic gain control, voice activity detection, jitter buffer management, packet loss concealment, etc.

FIG. 1 depicts the audio data being received by a music detection component 104 that may detect whether music is being detected in the captured audio data. For example, if audio data is detected by the music detection component 104, then the music detection component 104 may notify the user that music has been detected and/or turn off the music. The audio data captured by microphone 102 may also be received and processed by one or more other speech enhancement components, such as, e.g., echo cancelation component 106, noise suppression component 108, and/or dereverberation component 110. One or more of echo cancelation component 106, noise suppression component 108, and/or dereverberation component 110 may be speech enhancement components that provide microphone and speaker alignment, such as microphone 101 and speaker 134. Echo cancelation component 106, also referred to as acoustic echo cancelation component, may receive audio data captured by microphone 102 as well as speaker data played by speaker 134. Echo cancelation component 106 may be used to cancel acoustic feedback between speaker 134 and microphone 102 in speech communication systems.

Noise suppression component 108 may receive audio data captured by microphone 102 as well as speaker data played by speaker 134. Noise suppression component 108 may process the audio data and speaker data to isolate speech from other sounds and music during playback. For example, when microphone 102 is turned on, background noise around the user such as shuffling papers, slamming doors, barking dogs, etc. may distract other users. Noise suppression component 108 may remove such noises around the user in speech communication systems.

Dereverberation component 110 may receive audio data captured by microphone 102 as well as speaker data played by speaker 134. Dereverberation component 110 may process the audio data and speaker data to remove effects of reverberation, such as reverberant sounds captured up by microphones including microphone 102.

The audio data, after being processed by one or more speech enhancement components, such as one or more of echo cancelation component 106, noise suppression component 108, and/or dereverberation component 110, may be speech enhanced audio data, and further processed by one or more other speech enhancement components. For example, the speech enhanced audio data may be received and/or processed by one or more of echo detector 112 and/or automatic gain control component 114. Echo detector 112 may use the speech enhanced audio data to detect whether echoes are present in the speech enhanced audio data, and notify the user of the echo. Automatic gain control component 114 may use the speech enhanced audio data to amplify and/or increase the volume of the speech enhanced audio data based on whether speech is detected by voice activity detector 116.

Voice activity detector 116 may receive the speech enhanced audio data having been processed by automatic gain control component 114 and may detect whether voice activity is detected in the speech enhanced audio data. Based on the detections of voice activity detector 116, the user may be notified that he or she is speaking while muted, automatically turn on or off notifications, and/or instruct automatic gain control component 114 to amplify and/or increase the volume of the speech enhanced audio data.

The speech enhanced audio data may then be received by encoder 118 and/or NISQA 120. Encoder 118 may be an audio codec, such as an AI-powered audio codec, e.g., SATIN encoder, which is a digital signal processor with machine learning. Encoder 118 may encode (i.e., compress) the audio data for transmission over network 122. Upon encoding, encoder 118 may transmit the encoded speech enhanced audio data to the network 122 where other components of the speech communication system are provided. The other components of the speech communication system speech may then transmit over network 122 audio data of the user and/or other users of the speech communication system.

A jitter buffer management component 124 may receive the audio data that is transmitted over network 122 and process the audio data. For example, jitter buffer management component 124 may buffer packets of the audio data in order to allow decoder 126 to receive the audio data in evenly spaced intervals. Because the audio data is transmitted over the network 122, there may be variations in packet arrival time, i.e., jitter, that may occur because of network congestion, timing drift, and/or route changes. The jitter buffer management component 124, which is located at a receiving end of the speech communication system, may delay arriving packets so that the user experiences a clear connection with very little sound distortion.

The audio data from the jitter buffer management component 124 may then be received by decoder 126. Decoder 126 may be an audio codec, such as an AI-powered audio codec, e.g., SATIN decoder, which is a digital signal processor with machine learning. Decoder 126 may decode (i.e., decompress) the audio data received from over the network 122. Upon decoding, decoder 126 may provide the decoded audio data to packet loss concealment component 128.

Packet loss concealment component 128 may receive the decoded audio data and may process the decoded audio data to hide of gaps in audio streams caused by data transmission failures in the network 122. The results of the processing may be provided to one or more of network quality classifier 130, call quality estimator component 132, and/or speaker 134.

Network quality classifier 130 may classify a quality of the connection to the network 122 based on information received from jitter buffer management component 124 and/or packet loss concealment component 128, and network quality classifier 130 may notify the user of the quality of the connection to the network 122, such as poor, moderate, excellent, etc. Call quality estimator component 132 may estimate a quality of a call when the connection to the network 122 is through a public switched telephone network (PSTN). Speaker 134 may play the decoded audio data as speaker data. The speaker data may also be provided to one or more of echo cancelation component 106, noise suppression component 108, and/or dereverberation component 110.

As mentioned above, the speech enhanced audio data may then be received by NISQA 120. NISQA 120 may be one or more of the above-discussed NISQA using neural networks may be trained to detect a quality of the speech enhanced audio data. Upon detecting the quality of the speech enhanced audio data, the results may be provided to optimized speech enhanced component(s) 136. The optimized speech enhanced component(s) 136 may determine whether one or more of the speech enhancement components may be changed to another speech enhancement component to improve the QoE. In the embodiment the optimized speech enhanced component(s) 136 may be stored on a device of the user and may store two or more of the various speech enhancement components discussed above. Based on the results of the NISQA 120 the optimized speech enhanced component(s) 136 may dynamically and/or in real time change the various speech enhancement components, such as music detection component 104, echo cancelation component 106, noise suppression component 108, dereverberation component 110, echo detector 112, automatic gain control component 114, jitter buffer management component 124, and/or packet loss concealment component 128. For the sake of clarity in the figures, optimized speech enhanced component(s) 136, 236, 336, 436, 536, etc. are not shown being connected to each of the speech of the enhancement components, but may be connected to each of the speech enhancements components.

For example, optimized speech enhanced component(s) 136 may change the noise suppression component 108 to another type of noise suppression component. Then, a new quality of the speech enhanced audio data may be detected by NISQA 120. If the new quality of the speech enhanced audio data is higher than original quality of the speech enhanced audio data, the optimized speech enhanced component(s) 136 may keep the changed noise suppression component 108. If the new quality of the speech enhanced audio data is not higher than original quality of the speech enhanced audio data, the optimized speech enhanced component(s) 136 may change the changed noise suppression component 108 back to the original noise suppression component 108 or to another type of noise suppression component.

An exemplary brute force method pseudo code for implementing optimization is depicted below.

```
  // try all speech enhancement models to find the best quality one
  Best_SE_components = Default_SE_components
  MOS_best = NISQA(SE output)
  MOS_default = MOS_best
  For S in all SE component models
    Use component S
    // skip speech enhancement component combinations that take
  too long to run
    If time to run SE components > max_SE_time
      Continue
    End
    MOS=NISQA(SE output)
    If MOS > MOS_best
      Use S in Best_SE_components
      MOS_best = MOS
    End
  End
  // only use the new settings if the improvement is significant enough
(e.g., T=0.1 MOS is noticeable)
  If MOS_best - MOS_default > T
    Default_SE_components = Best_SE_components
  End
```

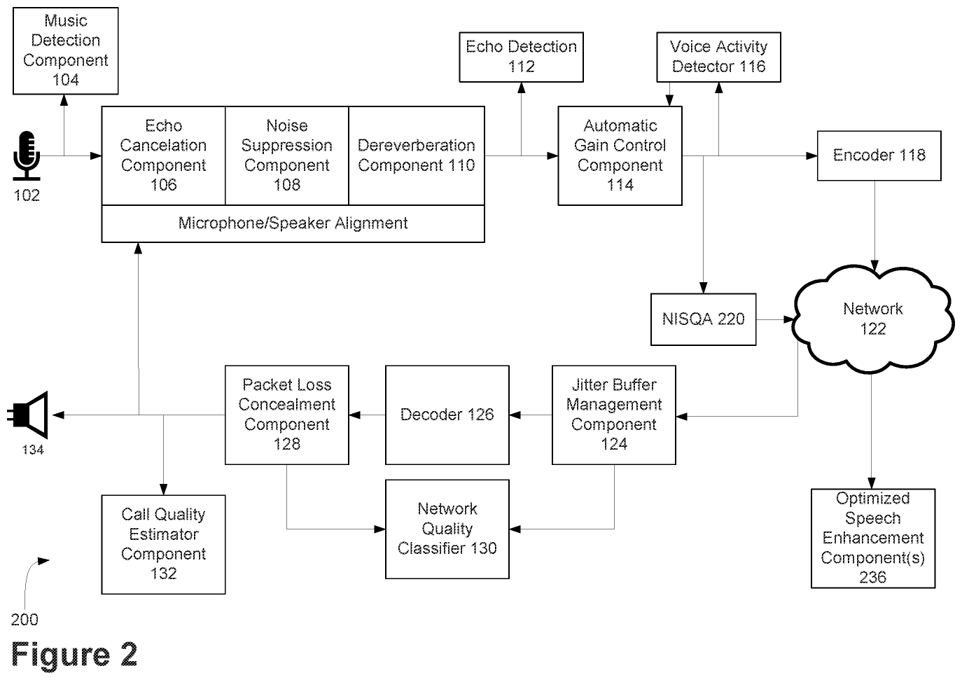

FIG. 2 depicts another exemplary speech enhancement architecture 200 of a speech communication system pipeline, according to embodiments of the present disclosure. Specifically, FIG. 2 depicts speech communication system pipeline having a plurality of speech enhancement components. FIG. 2 is similar to the embodiment shown in FIG. 1 except that optimized speech enhancement component(s) 236 resides over the network 122 and/or in a cloud, and NISQA 220 transmits the optimized speech enhancement component(s) 236 over the network 122. NISQA 220 may be one or more of the above-discussed NISQA using neural networks may be trained to detect a quality of the speech enhanced audio data. Upon detecting the quality of the speech enhanced audio data, the results may be provided to optimized speech enhanced component(s) 236 over the network 122. The optimized speech enhanced component(s) 236 may determine whether one or more of the speech enhancement components may be changed to another speech enhancement component to improve the QoE. In the embodiment the optimized speech enhanced component(s) 236 transmit back to the device of the user where various speech enhancement components may be stored. Based on the results of the NISQA 220, the optimized speech enhanced component(s) 236 may dynamically and/or in near real time, depending on a speed of the connection to the network and/or a quality of connection to the network 122, change the various speech enhancement components, such as music detection component 104, echo cancelation component 106, noise suppression component 108, dereverberation component 110, echo detector 112, automatic gain control component 114, jitter buffer management component 124, and/or packet loss concealment component 128.

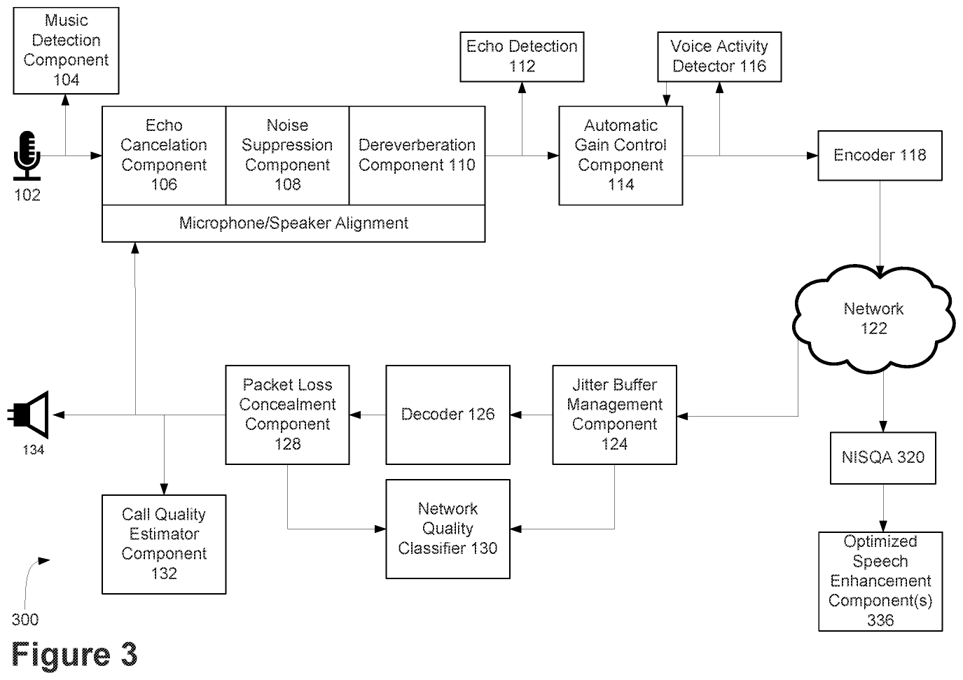

FIG. 3 depicts yet another exemplary speech enhancement architecture 300 of a speech communication system pipeline, according to embodiments of the present disclosure. FIG. 3 is similar to the embodiment shown in FIG. 2 except that NISQA 320 and optimized speech enhancement component(s) 236 reside over the network 122 and/or in a cloud. NISQA 320 may receive the encoded speech enhanced audio data, and detect the quality of the encoded speech enhanced audio data. NISQA 320 may be one or more of the above-discussed NISQA using neural networks may be trained to detect a quality of the speech enhanced audio data. Upon detecting the quality of the encoded speech enhanced audio data, the results may be provided to optimized speech enhanced component(s) 336 over the network 122. The optimized speech enhanced component(s) 336 may determine whether one or more of the speech enhancement components may be changed to another speech enhancement component to improve the QoE. In the embodiment the optimized speech enhanced component(s) 336 transmit back to the device of the user where various speech enhancement components may be stored. Based on the results of the NISQA 320, the optimized speech enhanced component(s) 336 may dynamically and/or in near real time, depending on a speed of the connection to the network and/or a quality of connection to the network 122, change the various speech enhancement components, such as music detection component 104, echo cancelation component 106, noise suppression component 108, dereverberation component 110, echo detector 112, automatic gain control component 114, jitter buffer management component 124, and/or packet loss concealment component 128.

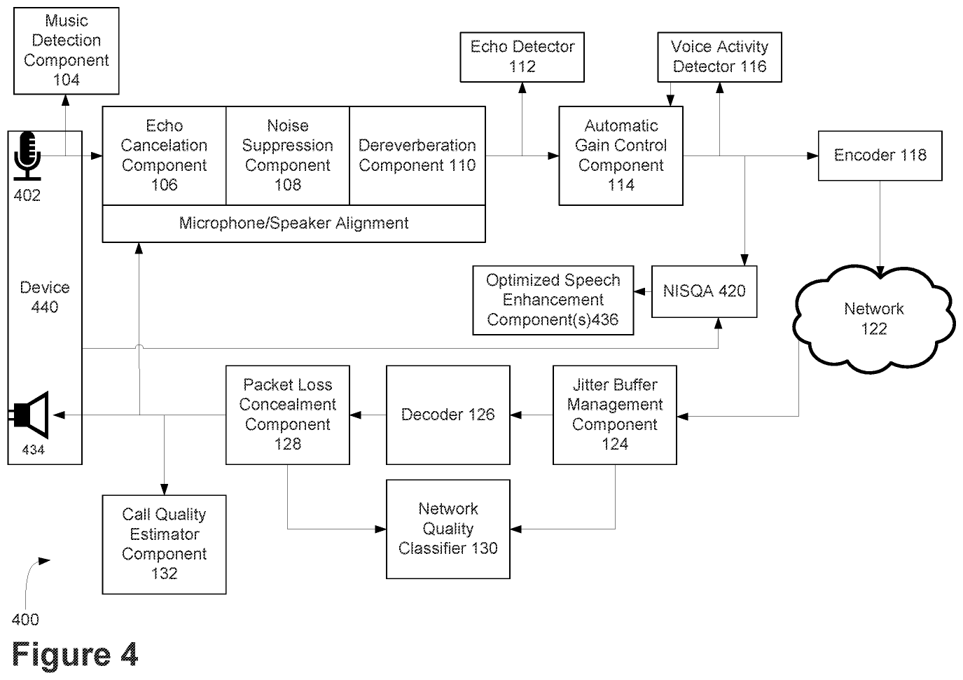

FIG. 4 depicts still yet another exemplary speech enhancement architecture 400 of a speech communication system pipeline, according to embodiments of the present disclosure. Specifically, FIG. 4 depicts speech communication system pipeline having a plurality of speech enhancement components. While FIG. 4 is shown to be similar to the embodiment shown in FIG. 1, FIG. 4 may implement in a similar manner as the embodiments shown in FIGS. 2 and 3. As shown in FIG. 4, NISQA 420 may receive speech enhanced audio data as well as information from the device of the user, i.e., device 440 that includes microphone 402, speaker 434, and well as other various components of the device 440. The information may include device information of a device, i.e., microphone 402, that captured the audio data. The NISQA 420 may detect the quality of the speech of the audio data based on the received device information. For example, depending on a microphone type the quality of the audio data may change, and the NISQA may instruct the optimized speech enhancement component(s) 436 to change one or more of the speech enhancement components based on the detected quality of the speech and the device information. Additionally, and/or alternatively, when a change in the device information is detected, such as a change of the microphone 402, depending on the new microphone type the quality of the audio data may change, and the NISQA may instruct the optimized speech enhancement component(s) 436 to change one or more of the speech enhancement components based on the detected quality of the speech and the device information that changed. Moreover, instead of microphone or speaker information, NISQA 420 may receive environment information of the device 440 that is capturing the audio data. The NISQA 420 may detect the quality of the speech of the audio data based on the received environment information. The NISQA may instruct the optimized speech enhancement component(s) 436 to change one or more of the speech enhancement components based on the detected quality of the speech and the environment information and/or when the environment information changes. Furthermore, NISQA 420 may receive a load of at least one processor of the device 440 that is capturing the audio data. The NISQA 420 may detect the quality of the speech of the audio data that may also be based on the load of at least one processor of the device 440. The NISQA may instruct the optimized speech enhancement component(s) 436 to change one or more of the speech enhancement components based on the detected quality of the speech and the load of at least one processor of the device 440. For example, if the load is high, performance may degrade, or if the load is low, more processor intensive speech enhancement components may be used.

Based on the results of the NISQA 420 the optimized speech enhanced component(s) 436 may dynamically and/or in real time change the various speech enhancement components, such as music detection component 104, echo cancelation component 106, noise suppression component 108, dereverberation component 110, echo detector 112, automatic gain control component 114, jitter buffer management component 124, and/or packet loss concealment component 128.

Additionally, and/or alternatively, the one or more speech enhancement components that improve speech may be reported back to a server over the network, along with a make and/or model of the device with the improved speech enhancement. In turn, the server may aggregate such reports from a plurality of devices from a plurality of users, and the one or more speech enhancement components may be uses in systems with the same make and/or model of the reporting device.

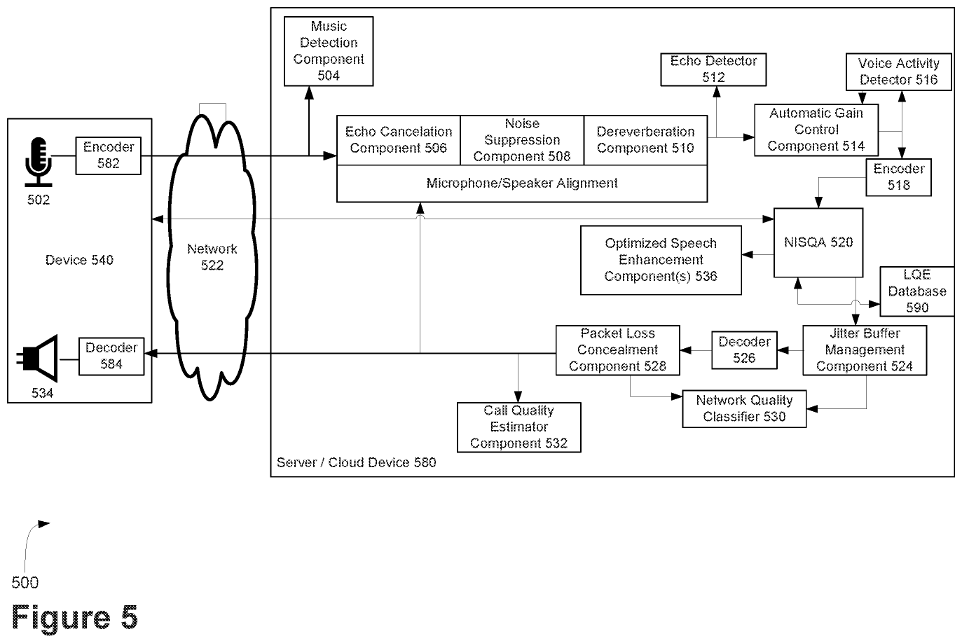

FIG. 5 depicts cloud-based exemplary speech enhancement architecture 500 of a speech communication system pipeline, according to embodiments of the present disclosure. Specifically, FIG. 5 depicts speech communication system pipeline having a plurality of speech enhancement components that reside in server/cloud device 580. FIG. 5 is shown to be similar to the embodiment shown in FIGS. 1-4 and may be implemented in a similar manner as the embodiments shown in FIGS. 1-4. FIG. 5 is also similar to the embodiment shown in FIG. 3 where the NISQA 520 and optimized speech enhancement component(s) 536 reside over the network 122 and/or in a cloud on the server/cloud device 580. NISQA 520 may receive the encoded speech enhanced audio data, and detect the quality of the encoded speech enhanced audio data. NISQA 520 may be one or more of the above-discussed NISQA using neural networks may be trained to detect a quality of the speech enhanced audio data.

The cloud-based exemplary speech enhancement architecture 500 may support many types of endpoints (devices 540). Some types of devices 540 may not have high-quality audio. For example, a device 540 may be a web-based client, which may use Web Real-Time Communication (WebRTC). WebRTC may provide web browsers and/or mobile applications with real-time communication (RTC) via application programming interfaces (APIs). WebRTC may allow audio and video communication to work inside web pages by allowing direct peer-to-peer communication without needing to install plugins or download native applications.

Web-based client devices 540, such as web browsers and/or mobile applications using WebRTC, may have an increased poor call quality (>10%), as compared to other types of non-web-based client devices 540. NISQA 520 may detect poor quality calls, including impairments of one or more of noise, device, echo, reverberation, speech level, etc. When a poor quality send signal is detected from an endpoint (devices 540) using NISQA 520, an appropriate cloud-based speech enhancement model may be applied to mitigate the impairment, as discussed in more detail below.

As shown in FIG. 5, microphone 502 of device 540 may capture audio data. The audio data may then be received by encoder 582. Encoder 582 may take the audio data captured by microphone 502 for use in a web-based device 540, and may transmit the audio data to server/cloud device 580. Additionally, and/or alternative, encoder 582 may be an audio codec, such as an AI-powered audio codec, e.g., SATIN encoder, which is a digital signal processor with machine learning. Encoder 582 may encode (i.e., compress) the audio data for transmission over network 522. Upon encoding, encoder 582 may transmit the encoded audio data to the server/cloud device 580 via the network 522 where speech enhancement components of the speech communication system are provided.

FIG. 5 depicts the audio data being received by a music detection component 504 that may detect whether music is being detected in the captured audio data. For example, if audio data is detected by the music detection component 504, then the music detection component 504 may notify the user that music has been detected. The audio data captured by microphone 502 may also be received and processed by one or more other speech enhancement components, such as, e.g., echo cancelation component 506, noise suppression component 508, and/or dereverberation component 510. One or more of echo cancelation component 506, noise suppression component 508, and/or dereverberation component 510 may be speech enhancement components that provide microphone and speaker alignment, such as microphone 502 and speaker 534. Echo cancelation component 506, also referred to as acoustic echo cancelation component, may receive audio data captured by microphone 502 as well as speaker data played by speaker 534. Echo cancelation component 506 may be used to cancel acoustic feedback between speaker 534 and microphone 502 in speech communication systems.

Noise suppression component 508 may receive audio data captured by microphone 502 as well as speaker data played by speaker 534. Noise suppression component 508 may process the audio data and speaker data to isolate speech from other sounds and music during playback. For example, when microphone 502 is turned on, background noise around the user such as shuffling papers, slamming doors, barking dogs, etc. may distract other users. Noise suppression component 508 may remove such noises around the user in speech communication systems.

Dereverberation component 510 may receive audio data captured by microphone 502 as well as speaker data played by speaker 534. Dereverberation component 510 may process the audio data and speaker data to remove effects of reverberation, such as reverberant sounds captured up by microphones including microphone 502.

The audio data, after being processed by one or more speech enhancement components, such as one or more of echo cancelation component 506, noise suppression component 508, and/or dereverberation component 510, may be speech enhanced audio data, and further processed by one or more other speech enhancement components. For example, the speech enhanced audio data may be received and/or processed by one or more of echo detector 512 and/or automatic gain control component 514. Echo detector 512 may use the speech enhanced audio data to detect whether echoes are present in the speech enhanced audio data, and notify the user of the echo. Automatic gain control component 514 may use the speech enhanced audio data to amplify and/or increase the volume of the speech enhanced audio data based on whether speech is detected by voice activity detector 516.

Voice activity detector 516 may receive the speech enhanced audio data having been processed by automatic gain control component 514 and may detect whether voice activity is detected in the speech enhanced audio data. Based on the detections of voice activity detector 516, the user may be notified that he or she is speaking while muted, automatically turn on or off notifications, and/or instruct automatic gain control component 514 to amplify and/or increase the volume of the speech enhanced audio data.

A jitter buffer management component 524 may receive the audio data that is transmitted over network 522 and process the audio data. For example, jitter buffer management component 524 may buffer packets of the audio data in order to allow decoder 526 to receive the audio data in evenly spaced intervals. Because the audio data is transmitted over the network 522, there may be variations in packet arrival time, i.e., jitter, that may occur because of network congestion, timing drift, and/or route changes. The jitter buffer management component 524 may delay arriving packets so that the user experiences a clear connection with very little sound distortion.

The audio data from the jitter buffer management component 524 may then be received by decoder 526. Decoder 526 may be an audio codec, such as an AI-powered audio codec, e.g., SATIN decoder, which is a digital signal processor with machine learning. Decoder 526 may decode (i.e., decompress) the audio data received from over the network 522. Upon decoding, decoder 526 may provide the decoded audio data to packet loss concealment component 528.

Packet loss concealment component 528 may receive the decoded audio data and may process the decoded audio data to hide of gaps in audio streams caused by data transmission failures in the network 522. The results of the processing may be provided to one or more of network quality classifier 530, call quality estimator component 532, and/or device 540. Network quality classifier 530 may classify a quality of the connection to the network 522 based on information received from jitter buffer management component 524 and/or packet loss concealment component 528, and network quality classifier 530 may notify the user of the quality of the connection to the network 522, such as poor, moderate, excellent, etc. Call quality estimator component 532 may estimate a quality of a call when the connection to the network 522 is through a public switched telephone network (PSTN).

After processing the audio data, server/cloud device 580 may transmit the speech enhanced audio data back to device 540 via network 522. Decoder 584 may receive the processed audio data in the web-based device 540, and provide the processed audio data to speaker 534 for playback. Additionally, and/or alternatively, decoder 584 may be an audio codec, such as an AI-powered audio codec, e.g., SATIN decoder, which is a digital signal processor with machine learning. Decoder 526 may decode (i.e., decompress) the audio data received from over the network 522. Upon decoding, decoder 526 may provide the decoded audio data to speaker 534 for playback. Speaker 534 may play the decoded audio data as speaker data. The speaker data may also be provided to one or more of echo cancelation component 506, noise suppression component 508, and/or dereverberation component 510.

As shown in FIG. 5, NISQA 520 may receive audio data that has been modified to produce speech enhanced audio data. NISQA 520 may also receive information from the device of the user, i.e., device 540 that includes microphone 502, speaker 534, and well as other various components of the device 540. The information may include device information of a device, i.e., microphone 502, that captured the audio data.

NISQA 520 may determine whether device 540 is a low-quality endpoint. When NISQA 520 determines that a particular device 540 is a low-quality endpoint, NISQA 520 may instruct the particular device 540 to turn off audio processing on the particular device 540, and NISQA 520 may instruct the server/cloud device 580 to implement and/or change the one or more of the speech enhancement components. For example, NISQA 520 may detect a particular device 540 is a low-quality endpoint, when NISQA 520 detects that the particular device 540 is a web-based client and/or using WebRTC.

For example, if a particular device 540 is a low-quality endpoint, such as a web browser using WebRTC, a rating of a user of the speech communication system may be low. Further, if the particular device 540 is a web browser using WebRTC, then NISQA 520 may not be able to instruct the web browser how to process audio data using speech enhancement components. Thus, by moving speech enhancement to the server/cloud device 580, NISQA 520 may bypass the audio processing in the low-quality endpoint, such as a web browser using WebRTC.

Additionally, and/or alternatively, NISQA 520 may also receive information about a particular device 540, i.e., microphone 502, speaker 534, and well as other various components of the particular device 540, and determine whether the particular device 540 is a low-quality endpoint. When NISQA 520 determines that a particular device 540 is a low-quality endpoint, NISQA 520 may instruct the particular device 540 to turn off audio processing on the particular device 540, 540, and NISQA 520 may instruct the server/cloud device 580 to implement and/or change the one or more of the speech enhancement components. In one example, NISQA 520 may score and/or determine capabilities of devices 540 based on one or more of device information, connection type (i.e., web-based and/or WebRTC connections), and/or from a low-quality endpoint (LQE) database 590. LQE database 590 may comprise of listing of devices (i.e., devices 540) that have been predetermined to be of low quality. Additionally, NISQA 520 may score devices 540, and may store the scores in LQE database 590. For example, NISQA 520 may generate a score on a predetermined scale, such as 1 to 5 for quality, echo impairments, background noise, bandwidth distortions, etc. Then, NISQA 520 may use the updated LQE database 590 for determining device capabilities, along with additional indicators of low-quality endpoints (devices) for future speech communication sessions. When the score is below a predetermined threshold, then device 540 may be determined to be a low-quality endpoint.

NISQA 520 may detect the quality of the speech of the audio data based on the received audio data, and the NISQA 520 may instruct the optimized speech enhancement component(s) 536 to change one or more of the speech enhancement components that reside in the server/cloud device 580 based on the detected quality of the speech and the device information.

Based on the results of the NISQA 520 the optimized speech enhanced component(s) 536 may dynamically and/or in real time change the various speech enhancement components residing in the server/cloud device 580, such as music detection component 504, echo cancelation component 506, noise suppression component 508, dereverberation component 510, echo detector 512, automatic gain control component 514, jitter buffer management component 524, and/or packet loss concealment component 528.

In one example, when noisy speech is detected, then a cloud-based noise suppressor (noise suppression component 508) may be applied by the optimized speech enhancement component(s) 536. If echo is detected, a cloud-based echo canceller (echo cancelation component 506) may be applied by the optimized speech enhancement component(s) 536. NISQA 520 may be used to selectively apply these speech enhancement components on devices 540 that do not have high-quality audio, e.g., a device 540 that is a web-based client, which may minimize cost on the server/cloud device 580, which may have otherwise been required to execute these speech enhancement components on all calls and maximizing the quality.

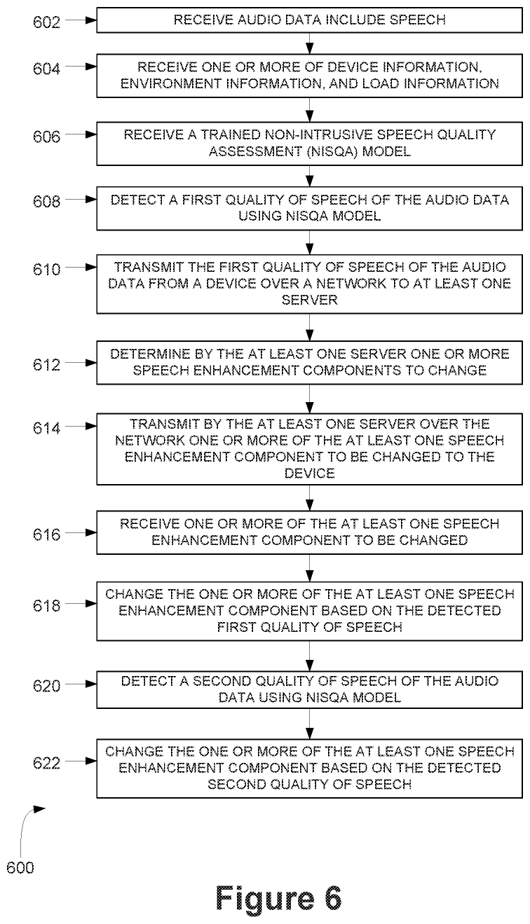

FIG. 6 depicts a method 600 for optimizing speech enhancement components to use in speech communication systems using non-intrusive speech quality assessment, according to embodiments of the present disclosure. The method 600 may begin at 602, in which audio data including speech may be received. The audio data having been processed by at least one speech enhancement component. As mentioned above, the at least one speech enhancement component may include one or more of acoustic echo cancelation, noise suppression, dereverberation, automatic gain control, packet loss concealment, etc.

In addition to receiving the audio data, one or more of device information of a device that captured the audio data, environment information of the device that captured the audio data, and a load of at least one processor of the device that captured the audio data may be received at 604.

Additionally, before, after, and/or during receiving the audio data, device information, environment information, and/or load of the at least one processor, a trained non-intrusive speech quality assessment (NISQA) model, also referred to as a NISQA using a neural network model, may be received at 606. Upon receiving the audio data and/or NISQA model, the trained NISQA model may detect a first quality of the speech of the audio data at 608. As in more detail mentioned above, the trained NISQA model may have been trained to detect quality of speech automatically through the use of robust data sets. In addition to the audio data received, the NISQA model may use one or more of device information, environment information, and/or load of the at least one processor to detect quality of the speech.

In certain embodiments of the present disclosure, the detected first quality of speech of the audio data by the NISQA model may be transmitted at 610 over a network to at least one server. The at least one server may determine at 612 one or more speech enhancement components to be changed by the device. Then, the at least one server may transmit at 614 to the device that captured the audio data the one or more of the at least one speech enhancement component to be changed. The one or more of the at least one speech enhancement component to be changed based on the transmitted detected first quality of speech may be received at 616 by the device that captured the audio data.

Based on the detected first quality of the speech, the one or more of the at least one speech enhancement component may be changed at 618 based on the detected first quality of the speech. The one or more speech enhancement components that are changed may include one or more of acoustic echo cancelation, noise suppression, dereverberation, automatic gain control, and packet loss concealment. Additionally, and/or alternatively, a change in the device information may be detected, and the one or more of the at least one speech enhancement component based on the detected quality of the speech may be changed when the change in the device information is detected.

After changing the one or more of the at least one speech enhancement component, a second quality of the speech of the audio data may be detected 620 using the trained NISQA model. Then, one or more of the at least one speech enhancement component may be changed at 622 based on the detected second quality of the speech. The changed speech enhancement component based on the detected second quality of the speech and the changed speech enhancement component based on the first quality of the speech effect the same speech enhancement component, such as the same acoustic echo cancelation, noise suppression, dereverberation, automatic gain control, and packet loss concealment. Next, a determination is made whether the detected second quality of the speech is higher than the detected first quality of the speech. When the detected second quality of the speech is higher than the detected first quality of the speech, the changed one or more of the at least one speech enhancement component based on the detected second quality of the speech may be kept. Conversely, when the detected second quality of the speech is not higher than the detected first quality of the speech, the one or more of the at least one speech enhancement component based on the detected first quality of the speech may be changed from the changed one or more of the at least one speech enhancement component based on the detected second quality of the speech to either the previous at least one speech enhancement component or to another speech enhancement component.

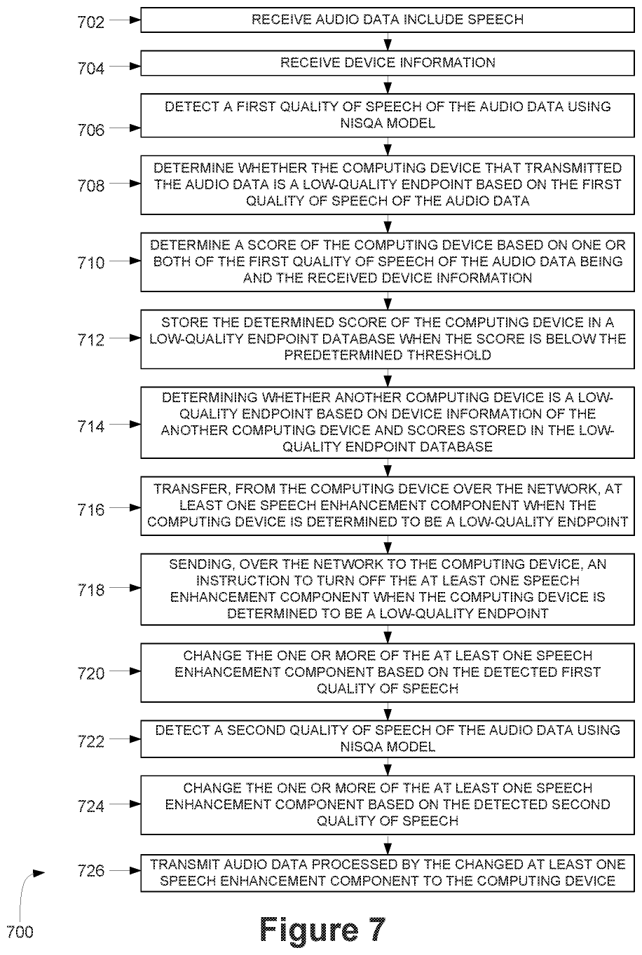

FIG. 7 depicts a method 700 for optimizing speech enhancement components to use in speech communication systems using non-intrusive speech quality assessment, according to embodiments of the present disclosure. The method 700 may begin at 702, in which audio data including speech may be received over a network from a computing device at a server/cloud device that implements a speech communication system. The audio data may or may not having been processed by at least one speech enhancement component. As mentioned above, the at least one speech enhancement component may include one or more of acoustic echo cancelation, noise suppression, dereverberation, automatic gain control, packet loss concealment, etc. In addition to receiving the audio data, device information of the computing device that captured the audio data may be received at 704.

Upon receiving the audio data, a trained non-intrusive speech quality assessment (NISQA) model, also referred to as a NISQA using a neural network model, may detect a first quality of the speech of the audio data at 706. As in more detail mentioned above, the trained NISQA model may have been trained to detect quality of speech automatically through the use of robust data sets. In addition to the audio data received, the NISQA model may use one or more of device information, environment information, and/or load of the at least one processor to detect quality of the speech.

At 708, the NISQA, such as NISQA 520, and/or a server/cloud device, such as server cloud device 580, may determine whether the computing device that transmitted the audio data is a low-quality endpoint based on the first quality of speech of the audio data. For example, determining whether the computing device is a low-quality endpoint may include detecting whether the computing device is a web-based computing device, such as a web browser using WebRTC. Alternatively, and/or additionally, the NISQA and/or server/cloud device may determine whether the computing device that transmitted the audio data is a low-quality endpoint based on the first quality of speech of the audio data being below a predetermined threshold and the received device information.

The NISQA and/or server/cloud device at 710 may determine a score of the computing device based on one or both of the first quality of speech of the audio data being and the received device information. For example, the NISQA and/or server/cloud device may generate a score on a predetermined scale, such as 1 to 5 for quality, echo impairments, background noise, bandwidth distortions, etc. When the score is below a predetermined threshold, then computing device may be determined to be a low-quality endpoint. Further, at 712, the NISQA and/or server/cloud device may store the determined score of the computing device in a low-quality endpoint database, such as LQE database 590, when the score is below the predetermined threshold. Then, at 714, the NISQA and/or server/cloud device may use scores stored in the low-quality endpoint database to determining whether another computing device is a low-quality endpoint based on device information of the another computing device. For example, the low-quality endpoint databased may be used for determining the computing device capabilities, along with additional indicators of low-quality endpoints (devices) for future speech communication sessions.

At 716, when the computing device is determined to be a low-quality endpoint, at least one speech enhancement component to at least one server device, such as server/cloud device 580, may be transferred from the computing device over the network. The at least one speech enhancement component to be transferred from the device over the network to the server/cloud device may be determined based on a score by the NISQA and/or information stored in the LQE database. Alternatively, when the computing device is determined to be a low-quality endpoint, all audio processing may be transferred to the at least one server device. Then, at 718, an instruction to turn off the at least one speech enhancement component and/or all audio processing may be sent over the network to the computing device when the computing device is determined to be a low-quality endpoint.

After transferring the at least one speech enhancement component and/or all audio processing to at least one server device, one or more of the at least one speech enhancement component may be changed based on the detected first quality of the speech at 720. After changing the one or more of the at least one speech enhancement component, a second quality of the speech of the audio data may be detected 722 using the trained NISQA model. Then, one or more of the at least one speech enhancement component may be changed at 724 based on the detected second quality of the speech. The audio data, having been processed by the changed at least one speech enhancement component, may be transmitted over the network to the computing device at 726.

As described above, all speech enhancement components may reside on the device side, all speech enhancement components may be on the server/cloud device side, or some speech enhancement components may reside on the device side and some speech enhancement components may reside on the server/cloud device side. For example, if the server/cloud device side receives narrow-band audio, which may be detected by the NISQA from the audio data received, a bandwidth expander may be added to make it full-band audio. Alternatively, for example, the device may have narrow-band playback capabilities, which may be detected by the NISQA from device information, such a microphone data, a speech enhancement component may be added that optimizes speech for narrow-band playback.

Detecting the use of a NISQA may be done by inspecting the user device for changes in speech enhancement components. Additionally, looking at network packets to see if something is downloaded other than audio data, or determine whether quality of speech telecommunication system suddenly improves with no active steps by the user. Additionally, if NISQA is stored client side, processor usage may be higher than running a speech telecommunication system alone.

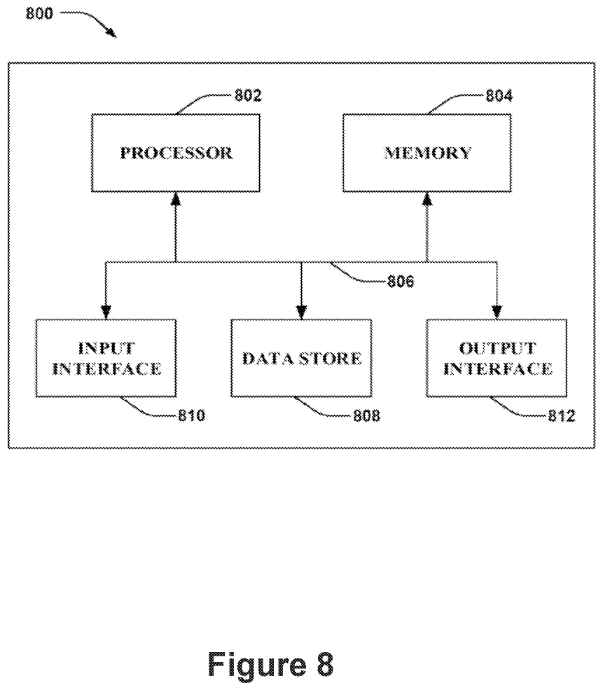

FIG. 8 depicts a high-level illustration of an exemplary computing device 800 that may be used in accordance with the systems, methods, modules, and computer-readable media disclosed herein, according to embodiments of the present disclosure. For example, the computing device 800 may be used in a system that processes data, such as audio data, using a neural network, according to embodiments of the present disclosure. The computing device 800 may include at least one processor 802 that executes instructions that are stored in a memory 804. The instructions may be, for example, instructions for implementing functionality described as being carried out by one or more components discussed above or instructions for implementing one or more of the methods described above. The processor 802 may access the memory 804 by way of a system bus 806. In addition to storing executable instructions, the memory 804 may also store data, audio, one or more neural networks, and so forth.

The computing device 800 may additionally include a data store, also referred to as a database, 808 that is accessible by the processor 802 by way of the system bus 806. The data store 808 may include executable instructions, data, examples, features, etc. The computing device 800 may also include an input interface 810 that allows external devices to communicate with the computing device 800. For instance, the input interface 810 may be used to receive instructions from an external computer device, from a user, etc. The computing device 800 also may include an output interface 812 that interfaces the computing device 800 with one or more external devices. For example, the computing device 800 may display text, images, etc. by way of the output interface 812.

It is contemplated that the external devices that communicate with the computing device 800 via the input interface 810 and the output interface 812 may be included in an environment that provides substantially any type of user interface with which a user can interact. Examples of user interface types include graphical user interfaces, natural user interfaces, and so forth. For example, a graphical user interface may accept input from a user employing input device(s) such as a keyboard, mouse, remote control, or the like and may provide output on an output device such as a display. Further, a natural user interface may enable a user to interact with the computing device 800 in a manner free from constraints imposed by input device such as keyboards, mice, remote controls, and the like. Rather, a natural user interface may rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 800 may be a distributed system. Thus, for example, several devices may be in communication by way of a network connection and may collectively perform tasks described as being performed by the computing device 800.

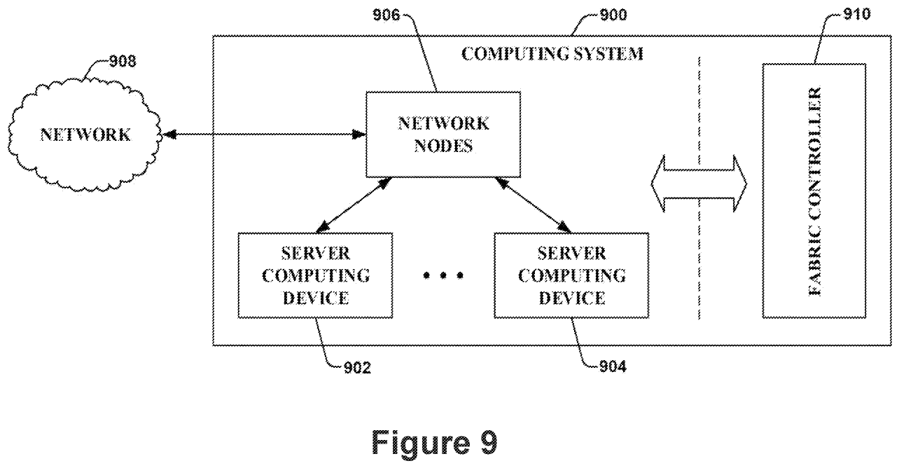

Turning to FIG. 9, FIG. 9 depicts a high-level illustration of an exemplary computing system 900 that may be used in accordance with the systems, methods, modules, and computer-readable media disclosed herein, according to embodiments of the present disclosure. For example, the computing system 900 may be or may include the computing device 800. Additionally, and/or alternatively, the computing device 800 may be or may include the computing system 900.

The computing system 900 may include a plurality of server computing devices, such as a server computing device 902 and a server computing device 904 (collectively referred to as server computing devices 902-904). The server computing device 902 may include at least one processor and a memory; the at least one processor executes instructions that are stored in the memory. The instructions may be, for example, instructions for implementing functionality described as being carried out by one or more components discussed above or instructions for implementing one or more of the methods described above. Similar to the server computing device 902, at least a subset of the server computing devices 902-904 other than the server computing device 902 each may respectively include at least one processor and a memory. Moreover, at least a subset of the server computing devices 902-904 may include respective data stores.

Processor(s) of one or more of the server computing devices 902-904 may be or may include the processor, such as processor 802. Further, a memory (or memories) of one or more of the server computing devices 902-904 can be or include the memory, such as memory 804. Moreover, a data store (or data stores) of one or more of the server computing devices 902-904 may be or may include the data store, such as data store 808.

The computing system 900 may further include various network nodes 906 that transport data between the server computing devices 902-904. Moreover, the network nodes 906 may transport data from the server computing devices 902-904 to external nodes (e.g., external to the computing system 900) by way of a network 908. The network nodes 902 may also transport data to the server computing devices 902-904 from the external nodes by way of the network 908. The network 908, for example, may be the Internet, a cellular network, or the like. The network nodes 906 may include switches, routers, load balancers, and so forth.

A fabric controller 910 of the computing system 900 may manage hardware resources of the server computing devices 902-904 (e.g., processors, memories, data stores, etc. of the server computing devices 902-904). The fabric controller 910 may further manage the network nodes 906. Moreover, the fabric controller 910 may manage creation, provisioning, de-provisioning, and supervising of managed runtime environments instantiated upon the server computing devices 902-904.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Various functions described herein may be implemented in hardware, software, or any combination thereof. If implemented in software, the functions may be stored on and/or transmitted over as one or more instructions or code on a computer-readable medium. Computer-readable media may include computer-readable storage media. A computer-readable storage media may be any available storage media that may be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, may include compact disc (“CD”), laser disc, optical disc, digital versatile disc (“DVD”), floppy disk, and Blu-ray disc (“BD”), where disks usually reproduce data magnetically and discs usually reproduce data optically with lasers. Further, a propagated signal is not included within the scope of computer-readable storage media. Computer-readable media may also include communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio and microwave are included in the definition of communication medium. Combinations of the above may also be included within the scope of computer-readable media.

Alternatively, and/or additionally, the functionality described herein may be performed, at least in part, by one or more hardware logic components. For example, and without limitation, illustrative types of hardware logic components that may be used include Field-Programmable Gate Arrays (“FPGAs”), Application-Specific Integrated Circuits (“ASICs”), Application-Specific Standard Products (“ASSPs”), System-on-Chips (“SOCs”), Complex Programmable Logic Devices (“CPLDs”), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

What is claimed is:

1. A computer-implemented method for optimizing speech enhancement components to use in speech communication systems using non-intrusive speech quality assessment, the method comprising:
receiving, from a computing device over a network, audio data, the audio data including speech;
detecting a first quality of the speech of the audio data using a trained non-intrusive speech quality assessment (NISQA) model, the trained NISQA model trained to detect quality of speech automatically;
determining whether the computing device is a low-quality endpoint based on the first quality of speech of the audio data being; and
transferring, from the computing device over the network, at least one speech enhancement component to at least one server device when the computing device is determined to be a low-quality endpoint.

2. The method according to claim 1, further comprising:
sending, over the network to the computing device, an instruction to turn off the at least one speech enhancement component when the computing device is determined to be a low-quality endpoint.

3. The method according to claim 1, further comprising:
sending, over the network to the computing device, an instruction to turn off audio processing when the computing device is determined to be a low-quality endpoint,
wherein transferring the at least one speech enhancement component to the at least one server device when the computing device is determined to be a low-quality endpoint includes:
transferring, from the computing device over the network, audio processing to the at least one server device when the computing device is determined to be a low-quality endpoint.

4. The method according to claim 1, further comprising:
changing, after transferring the at least one speech enhancement component to at least one server device, one or more of the at least one speech enhancement component based on the detected first quality of the speech; and
transmitting, to the computing device, the audio data having been processed by the changed at least one speech enhancement component.

5. The method according to claim 1, further comprising:
determining whether the computing device is a low-quality endpoint based on the first quality of speech of the audio data includes:
detecting whether the computing device is a web-based computing device.

6. The method according to claim 1, further comprising:
receiving device information of the computing device that captured the audio data,
wherein determining whether the computing device is a low-quality endpoint is further based on the received device information.

7. The method according to claim 6, further comprising:
determining a score of the computing device based on one or both of the first quality of speech of the audio data being and the received device information;
determining whether the determined score of the computing device is below a predetermined threshold; and
storing the determined score of the computing device in a low-quality endpoint database when the score is below the predetermined threshold.

8. The method according to claim 7, further comprising:
determining whether another computing device is a low-quality endpoint based on device information of the another computing device and scores stored in the low-quality endpoint database.

9. The method according to claim 1, further comprising:
changing one or more of the at least one speech enhancement component based on the detected first quality of the speech.
detecting, after changing the one or more of the at least one speech enhancement component, a second quality of the speech of the audio data using the trained NISQA model;
determining whether the detected second quality of the speech is higher than the detected first quality of the speech; and
when the detected second quality of the speech is not higher than the detected first quality of the speech, changing the changed at least one speech enhancement component; and
when the detected second quality of the speech is higher than the detected first quality of the speech, keeping the changed one or more of the at least one speech enhancement component.

10. The method according to claim 1, wherein the at least one speech enhancement component includes one or more of acoustic echo cancelation, noise suppression, dereverberation, automatic gain control, and packet loss concealment.

11. A system for optimizing speech enhancement components to use in speech communication systems using non-intrusive speech quality assessment, the system including:
a data storage device that stores instructions for optimizing speech enhancement components to use in speech communication systems using non-intrusive speech quality assessment; and
a processor configured to execute the instructions to perform a method including:
receiving, from a computing device over a network, audio data, the audio data including speech;
detecting a first quality of the speech of the audio data using a trained non-intrusive speech quality assessment (NISQA) model, the trained NISQA model trained to detect quality of speech automatically;
determining whether the computing device is a low-quality endpoint based on the first quality of speech of the audio data; and
transferring, from the computing device over the network, at least one speech enhancement component to the system when the computing device is determined to be a low-quality endpoint.

12. The system according to claim 11, wherein the processor is further configured to execute the instructions to perform the method including:
sending, over the network to the computing device, an instruction to turn off the at least one speech enhancement component when the computing device is determined to be a low-quality endpoint.

13. The system according to claim 11, further comprising:
sending, over the network to the computing device, an instruction to turn off audio processing when the computing device is determined to be a low-quality endpoint,
wherein transferring the at least one speech enhancement component to the at least one server device when the computing device is determined to be a low-quality endpoint includes:
transferring, from the computing device over the network, audio processing to the at least one server device when the computing device is determined to be a low-quality endpoint.

14. The system according to claim 11, further comprising:
changing, after transferring the at least one speech enhancement component to at least one server device, one or more of the at least one speech enhancement component based on the detected first quality of the speech; and
transmitting, to the computing device, the audio data having been processed by the changed at least one speech enhancement component.

15. The system according to claim 11, further comprising:
determining whether the computing device is a low-quality endpoint based on the first quality of speech of the audio data includes:
detecting whether the computing device is a web-based computing device.

16. The system according to claim 11, further comprising:
receiving device information of the computing device that captured the audio data,
wherein determining whether the computing device is a low-quality endpoint is further based on the received device information.

17. The system according to claim 16, further comprising:
determining a score of the computing device based on one or both of the first quality of speech of the audio data being and the received device information;
determining whether the determined score of the computing device is below a predetermined threshold; and
storing the determined score of the computing device in a low-quality endpoint database when the score is below the predetermined threshold.

18. The system according to claim 17, further comprising:
determining whether another computing device is a low-quality endpoint based on device information of the another computing device and scores stored in the low-quality endpoint database.

19. A computer-readable storage device storing instructions that, when executed by a computer, cause the computer to perform a method for optimizing speech enhancement components to use in speech communication systems using non-intrusive speech quality assessment, the method including:
receiving, from a computing device over a network, audio data, the audio data including speech;
detecting a first quality of the speech of the audio data using a trained non-intrusive speech quality assessment (NISQA) model, the trained NISQA model trained to detect quality of speech automatically;
determining whether the computing device is a low-quality endpoint based on the first quality of speech of the audio data; and
transferring, from the computing device over the network, at least one speech enhancement component to at least one server device when the computing device is determined to be a low-quality endpoint.

20. The computer-readable storage device according to claim 19, wherein the instructions that, when executed by the computer, cause the computer to perform the method further including:
sending, over the network to the computing device, an instruction to turn off the at least one speech enhancement component when the computing device is determined to be a low-quality endpoint.
